(19) United States
(12) Patent Application Publication
(10) Pub. No.: US 2026/0316051 A1
(43) Pub. Date: Oct. 15, 2026

(54) ANTI-SHATTER POROUS POLYMER COATINGS, METHOD OF MANUFACTURE THEREOF AND ARTICLES COMPRISING THE SAME

(71) Applicant: Mosaic Materials, Inc., Alameda, CA (US)

(72) Inventors: Ignacio Luz, Alameda, CA (US); Graham Wenz, Richmond, CA (US); Benjamin Yip, Fremont, CA (US)

(21) Appl. No.: 19/179,420

(22) Filed: Apr. 15, 2025

(51) Int. Cl. B01J 20/22; B01J 20/28; B01J 20/32

(52) U.S. Cl. CPC B01J 20/226; B01J 20/28007; B01J 20/28016; B01J 20/28059; B01J 20/3206; B01J 20/3223; B01J 20/3293

(57) ABSTRACT

A coated solid sorbent particle for adsorbing and storing a fluid includes a solid sorbent particle that is operative to adsorb the fluid. The coated solid sorbent particle includes a porous polymer coating disposed on the solid sorbent particle. A method of coating a fluid adsorbing solid sorbent particle includes disposing a porous polymer coating on the fluid adsorbing solid sorbent particle.

### BACKGROUND

This disclosure relates to anti-shatter, porous polymer coatings, methods of manufacture thereof and articles comprising the same. This disclosure also relates to polymer coated solid sorbents and to methods of manufacture thereof. In particular, this disclosure relates to anti-shatter, porous polymer coatings for solid sorbent particles, methods of manufacture thereof and articles comprising the same.

Currently, solid sorbents used for the capture of fluids have mechanical properties that can be improved. The progressive damage to the integrity of the solid sorbent forms can lead to irreversible, and sometimes drastic loss of the carbon dioxide capture performance which often leads to complete replacement of the sorbent particle.

The mechanical damage typically originates during changes in the flow dynamics across a material bed. The mechanical damage results in the creation of preferential flow pathways, clogging of airways with fines, undesirable incremental pressure drop, bed volume packing due to fragmentation, material loss, and drop in capture efficacy.

Depending on the configuration of the fluid capture system, (e.g., a fixed bed, a moving bed, a fluidized bed, and so on), the integrity of the initial sorbent forms can be subjected to different levels of mechanical stress, which dictates the type and degree of breakage. Types of breakage include cracking, crushing, shattering or a combination comprising at least one of the foregoing.

Cracking is due to the release of the material stress originated by thermal cycling, impact, compression forces including but not limited to weight, attachment points, and impact with system surfaces.

Crushing is due to attrition between particles, and compressive forces including but not limited to weight, attachment points, and impact with system surfaces.

Shattering is the fragmenting into smaller fines due to attrition, shearing forces, and friction.

Therefore, novel material approaches are desirable to provide good stability for solid sorbent particles.

### SUMMARY

Disclosed herein is a coated solid sorbent particle for adsorbing and storing a fluid, the coated particle comprising a solid sorbent particle that is operative to adsorb the fluid, and a porous polymer coating disposed on the solid sorbent particle.

Disclosed herein too is a method of coating a fluid-adsorbing solid sorbent particle, the method comprising disposing a porous polymer coating on the fluid-adsorbing solid sorbent particle.

### BRIEF DESCRIPTION OF THE DRAWINGS

The following descriptions should not be considered limiting in any way. With reference to the accompanying drawings, like elements are numbered alike:

FIG. 1A illustrates a coating on an particle.

FIG. 1B illustrates porous coatings on the solid sorbent particles;

FIG. 2A illustrates the effectiveness of the porous polymer coating disposed on the solid sorbent particle;

FIG. 2B illustrates the effectiveness of the porous polymer coating disposed on the solid sorbent particle;

FIG. 2C illustrates the effectiveness of the porous polymer coating disposed on the solid sorbent particle;

FIG. 3A illustrates the effectiveness of the coated solid sorbent particles for carbon dioxide adsorption;

FIG. 3B illustrates the effectiveness of the coated solid sorbent particles for carbon dioxide adsorption;

FIG. 3C illustrates the effectiveness of the coated solid sorbent particles for carbon dioxide adsorption; and

FIG. 4 illustrates the effectiveness of the porous polymer coating disposed on the solid sorbent particle.

### DETAILED DESCRIPTION

A detailed description of one or more embodiments of the disclosed apparatus and method are presented herein by way of exemplification and not limitation with reference to the figures.

Disclosed herein are solid sorbent particles that comprise a fluid adsorbing particle upon which is disposed a porous polymer coating. While the solid sorbent particles are primarily described herein as being in particular form, they can also be in the form of pellets, membranes, coatings, and so on. Their description herein as particles does not preclude their use in other forms such as membranes, pellets, coatings, and so on. The particle comprises a solid sorbent particle that adsorbs carbon dioxide with or without the porous polymeric coating disposed thereupon. The porous polymeric coating keeps the particle from shattering and producing fines or dust.

Disclosed herein too is a method for manufacturing porous polymeric coatings on the particle using a phase inversion technique. The method includes mixing the polymer with the sorbent in the presence of a solvent and an optional nonsolvent to form a mixture. The mixture is subjected to extrusion. In an embodiment, the change in pressure and temperature of the mixture as it emanates from the die during extrusion facilitates phase separation of the polymer from the sorbent particle resulting in the formation of a porous polymeric coating on the particle.

In an embodiment, the solvent is compatible with the polymer, while the non-solvent will not solvate the polymer. The non-solvent is added to the sorbent, solvent and polymer mixture in an amount sufficient to facilitate the phase separation of the polymer from the mixture resulting in the formation of a porous polymeric coating on the particle.

In an embodiment, the porous polymer coating is disposed on the sorbent particle by immersion precipitation. The method comprises mixing a polymer with a solvent to form a polymer solution. The polymer solution is cast on the sorbent particle and then submerged in a nonsolvent. In an embodiment, the sorbent can be wetted with the nonsolvent. The polymer solution is then mixed with the wetted sorbent. Due to the solvent and nonsolvent fluid exchange, the polymer precipitates on the surface of the sorbent to form a coating. This method of coating can be conducted via pan coating or dip coating.

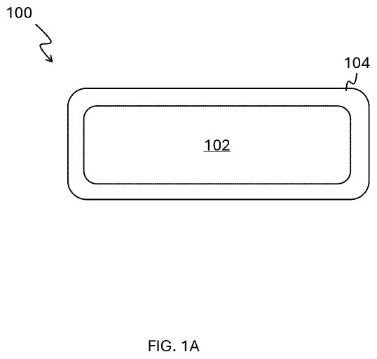

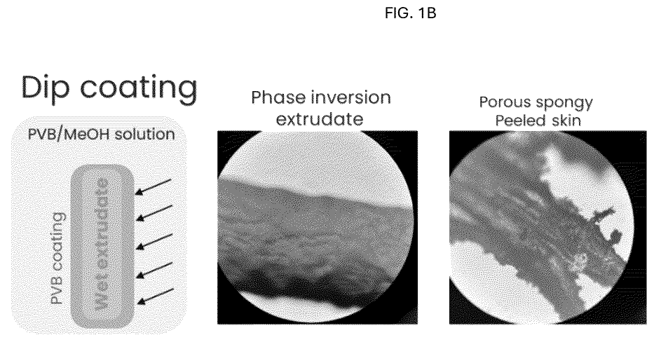

With reference now to FIG. 1A, a coated particle 100 comprises a solid sorbent particle 102 upon which is disposed the porous polymeric coating 104.

### The Solid Sorbent Particle

The solid sorbent particle 102 can adsorb a variety of different gases such as, for example, carbon dioxide, water vapor, nitrogen, carbon monoxide, sulfur dioxide, nitrogen oxides, and the like, that may be released as a byproduct from a manufacturing process, a combustion process, and the like. The particle 102 generally comprises a high surface area greater than 10 m²/gm, greater than 100 m²/gm and greater than 1000 m²/gm. It preferentially adsorbs carbon dioxide and water vapor over other gases such as nitrogen or oxygen. It may be surface treated with a functionalizing agent that helps it preferentially adsorb the carbon dioxide. The carbon dioxide adsorption may occur under ambient conditions (standard temperature and pressure) or at pressures that are greater than atmospheric pressure, or at temperatures that are greater than room temperature.

The sorbent particle is in the form of a powder prior to extrusion to form the coated particle. During extrusion, the sorbent powder is mixed with the polymer and solvents. After extrusion, phase separation produces a porous polymer film (the coating 104) on the surface of the solid sorbent particle (which is now in the form of a particle 102). In an embodiment, the porous polymer coating is formed directly on the surface of the solid sorbent particle 102.

Carbon dioxide is adsorbed into the solid sorbent particle 102 through van der Waals interactions. Carbon dioxide is adsorbed by the solid sorbent due to the molecule being polarizable and possessing a large quadrupole moment. Particle 102 can selectively bind carbon dioxide from a mixture of fluids (e.g., gases and/or liquids). The sorbent particle used in particle 102 for carbon dioxide adsorption may include porous, solid-phase materials, including mesoporous silicas, zeolites, polyamines with a polymeric backbone, and metal-organic frameworks.

Mesoporous silicates are materials with highly ordered, nanoscale porous structures that comprise pore sizes in the mesoporous range (2 to 50 nm). They are particularly attractive for carbon dioxide (CO₂) adsorption via physisorption due to their high surface area (greater than 1000 m²/gm), tunable pore size, and the ability to functionalize their surfaces with various chemical groups. Examples of mesoporous silicates include MCM-41, SBA-15, KIT-6, or a combination comprising at least one of the foregoing.

Mesoporous silicates and MOFs may be functionalized with amine groups to enhance their ability to adsorb carbon dioxide via chemisorption. Examples of amines used for functionalization include primary amines, secondary amines, tertiary amines, polymeric amines, or a combination comprising at least one of the foregoing. Examples of primary amines include methylamine, ethylamine, propylamine, ethylenediamine, monoethanolamine, and the like, or a combination comprising at least one of the foregoing. Examples of secondary amines include dialkylamines such as dimethylamine, diethylamine, dipropylamine, dibutylamine, diethanolamine, and the like, or a combination comprising at least one of the foregoing. Examples of tertiary amines include trimethylamine, triethylamine, tripropylamine, N,N-dimethylaniline, N-ethyldiethanolamine, and the like, or a combination comprising at least one of the foregoing.

Polymeric amines are polymers that contain amine groups (—NH₂, —NHR, or NR₂) in their backbone or as pendant side chains. These can be primary, secondary, or tertiary amines. Examples of polymeric amines include polyethyleneimine, poly(allylamine hydrochloride), poly(vinylamine), polyaniline, and the like, or a combination comprising at least one of the foregoing.

Zeolites are a class of porous aluminosilicate solids that rely upon physisorption. Zeolites are crystalline microporous materials widely used for carbon dioxide (CO₂) adsorption via physisorption due to their high surface area (greater than 10 m²/gm), tunable pore sizes 2 to 50 nanometers), and strong affinity for CO₂. Their unique properties make them particularly effective in adsorbing CO₂ from gas mixtures. Examples of zeolites include natural zeolites (e.g., clinoptilolite, mordenite, or a combination comprising at least one of the foregoing) or synthetic zeolites (e.g., Zeolite A (e.g., 4A, 5A), faujasite (X and Y), ZSM-5, or a combination comprising at least one of the foregoing). Combinations of natural zeolites and synthetic zeolites may also be used.

The metal-organic frameworks are tunable phase-change adsorbents for the efficient adsorption and storage of carbon dioxide through the use of specific pore sizes and organic linkers. The metal-organic framework may comprise an amine functionalized surface having two adjacent amines wherein an ammonium is formed from one amine and a carbamate is formed from the other amine. The metal-organic frameworks comprise a functionalized pore surface having adjacent amine adsorption sites that adsorb at least one carbon dioxide molecule. Adsorption sites adapt a regular, and repeating orientation. The orientation allows each site to contribute to the adsorption of at least one carbon dioxide molecules. Adsorption also occurs without a significant change in the volume of the adsorbent.

The metal-organic frameworks for carbon dioxide adsorption are metal atoms coordinatively bound to polytopic organic linkers that comprise pores whose dimensions permit the flow of gases and have interior surfaces that expose coordinatively unsaturated metal ions. The metal-organic framework is further functionalized with ligands that are bound to the coordinatively unsaturated metal ions that expose amines to the pore volumes.

In an embodiment, the metal is one or more atoms selected from the group comprising aluminum, beryllium, calcium, cadmium, cobalt, chromium, copper, iron, magnesium, manganese, nickel, scandium, titanium, vanadium, or zinc.

The structure of the metal-organic framework is determined in part by the rigid or semi-rigid polytopic organic linkers that are used in its formation. Specific polytopic linker molecules include aromatic compounds with two or more functional groups such as pyrazolate (—C₃H₂N₂), triazolate (—C₂HN₃), tetrazolate (—CN₄) or carboxylate (—CO₂) groups.

In one embodiment, the polytopic linker comprises one or more linkers selected from the group comprising 1,3,5-benzenetripyrazolate; 1,3,5-benzenetrisinazoiate; 1,3,5-benzenetristetrazolate, 1,3,5-benzenetricarboxylate; 1,4-benzenedicarboxylate; and 2,5-dioxido-1,4-benzenedicarboxylate.

In another embodiment, the linkers comprise two or more cyclic rings, two carboxylate groups, and two oxido groups such as 4,4′-dioxido-3,3′-biphenyldicarboxylate and 4′-4″-dioxido-3′,3″-terphenyldicarboxylate.

There are many combinations of metals and polytopic linkers that can be fashioned to provide metal-organic frameworks with desirable pore sizes and open metal sites. For example, in an embodiment, the metal-organic framework comprises a metal selected from the group consisting of calcium, iron, manganese, copper, cobalt, nickel, chromium or cadmium and the polytopic linker is 1,3,5-benzenetripyrazolate. In another embodiment, the metal is selected from the group consisting of calcium, iron, manganese, copper, cobalt, nickel, chromium, or cadmium and the polytopic linker is 1,3,5-benzenetristetrazolate.

Another specific metal-organic framework comprises a metal selected from the group consisting of magnesium, calcium, scandium, titanium, vanadium, chromium, manganese, iron, cobalt, nickel, copper, or zinc and the polytopic ligand is 4,4′-dioxidobiphenyl-3,3′-dicarboxylate.

For carbon dioxide adsorption, an amine ligand is particularly useful. The amine can be a monoamine; a diamine such as a primary/primary diamine, a primary/secondary diamine, a primary/tertiary diamine, and a secondary/secondary diamine; a polyamine such as a triamine, a tetramine, and an aminopolymer; or a bifunctional amine. The amines may include tetraamines, pentamines, polyamine species, and the like, or a combination comprising at least one of the foregoing. In this case the metal-organic framework composition comprises adjacent amine groups where exposure to carbon dioxide results in reversible formation of an ammonium carbamate complex.

As used herein, a bifunctional amine refers to an amine having an additional functional group other than an amino group. Examples of the bifunctional amines include, but are not limited to, amino-alcohols (also known as alkanolamines).

For example, in an embodiment, the ligand is a primary, secondary, or tertiary amines. Both acyclic and cyclic amine ligands may be used. In another embodiment, the ligand is a primary amine, a secondary amine, a tertiary amine, a polymeric amine, or a combination comprising at least one of the foregoing. Amine containing ligands can have one, two, or more amine groups. The functionalizing ligand is a diamine, or polyamines. Suitable ligand diamines comprise a combination of at least one or more of the foregoing ethylenediamine, propylenediamine, butylenediamine, pentylenediamine, hexylenediamine, 1,2-propanediamine, 2,3-butanediamine, 1,2-diamino-2-methylpropane, N-boc-ethylenediamine, N-ethylethylenediamine, N,N′-diethylpropylenediamine, N,N-diethylethylenediamine, N-isopropylethylenediamine, N,N′-diisopropylethylenediamine, N-isopropylpropylenediamine, N,N′-diisopropylpropylenediamine, N,N′-diisopropylethylenediamine, N-methylethylenediamine, N,N′-dimethylethylenediamine, N-methylpropylenediamine, N,N′-dimethylpropylenediamine, 1,3-diaminocyclohexane, N,N-dimethylethylenediamine, N,N,N′-trimethylethylenediamine, N,N,N′,N′-tetramethylethylenediamine, N-trimethylsilylethylenediamine, N,N-bis(trimethylsilyl)ethylenediamine, N,N′-bis(trimethylsilyl)ethylenediamine, N,N-dimethylpropylenediamine, N,N,N′-trimethylpropylenediamine, N,N,N′,N′-tetramethylpropylenediamine, diethylenetriamine, 2-(2-aminoethyoxy)ethylamine, dipropylenetriamine, 1,2-diaminocyclohexane, piperazine, and tris(2-aminoethyl)amine. Suitable polyamines include, but are not limited to, bis(3-aminopropyl)amine, N,N′-bis(3-aminopropyl)-1,4-butanediamine, tetraethylene pentaamine, polyethyleneimine, and polypropyleneimine. Other ligands include 2-(diisopropylphosphino)ethylamine N-methylethanolamine, and monoethanolamine.

One particularly specific configuration for carbon dioxide adsorption is a metal-organic framework formed from a 4,4′-dioxidobiphenyl-3,3′-dicarboxylate polytopic ligand and a ligand of N,N′-dimethylethylenediamine and the metal is selected from the group consisting of magnesium, calcium, scandium, titanium, vanadium, chromium, manganese, iron, cobalt, nickel, copper or zinc.

The solid sorbent used in the particle 102 is generally present in an amount of 30 to 98 wt %, based on a total weight of the coated particle. In an exemplary embodiment, the sorbent particle used in the particle 102 is generally present in an amount of 75 to 95 wt %, based on a total weight of the coated particle.

### The Porous Polymer Coating

The polymer used in the porous polymeric coating is one that is not compatible with the sorbent particle at the storage temperature of the coated particles. The polymer preferably does not enter into the pores of the solid sorbent. The polymer is not one that coats the pores to prevent fluid (e.g., gas or liquid) adsorption. This lack of compatibility between the polymer and the sorbent particle facilitates a phase separation between the solid sorbent particle and polymer upon being extruded. The polymer phase separates from the solid sorbent particle after emanating from the extruder and forms a porous skin on the surface of the solid sorbent particle thus producing the coated particle. The porous polymer coating has a surface area of 0.5 to 5 m²/gm, 1 to 3 m²/gm.

The polymer used to form the porous polymer coating is an organic polymer. The organic polymer may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, a random copolymer, a gradient copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers comprise number average molecular weights greater than 10,000 grams per mole, preferably greater than 20,000 g/mole and more preferably greater than 50,000 g/mole.

The organic polymer can comprise polyacetals, polyolefins (e.g., polyethylene, polypropylene, blends and copolymers thereof), polyacrylics, polycarbonates, polystyrenes, polyesters, polyamides, polyamideimides, polyacrylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polyethylene terephthalate, polybutylene terephthalate, polyurethane, polytetrafluoroethylene, perfluoroelastomers, fluorinated ethylene propylene, perfluoroalkoxyethylene, polychlorotrifluoroethylene, polyvinylidene fluoride, polysiloxanes, or the like, or a combination comprising at least one of the foregoing.

The organic polymers can further comprise polyvinyl butyral, polylactic acid, poly(ethylene glycol), polycaprolactone, polyhydroxybutyrate, poly(butylene adipate-co-terephthalate), and poly(lactic-co-glycolic acid), polyhydroxy-butyrate-valerate, polyorthoester, polyethylene oxide-butylene terephthalate, poly-D, L-lactic acid-p-dioxanone-polyethylene glycol block copolymer, poly(2-hydroxyethyl methacrylate), poly-2-hydroxyethylacrylate, poly(N-isopropylacrylamide), polyamines and polyethyleneimines, polyvinyl alcohol, polyacrylamides, polyacrylic acid, polymethacrylic acid, poly(glycerol)sebacate, poly(serinol sebacate), polystyrene, polycarbonate, polymethylmethacrylate, polyetherimides, polyimides, copolymers of ethylene and α-olefins, copolymers of propylene and α-olefins, polyesters such as polyethylene terephthalate, polybutylene terephthalate, ethylenically unsaturated groups such as vinyl, allyl, allenyl, norbornyl, ethynyl, acrylates, methacrylates, itaconates, maleimides, maleic anhydride and maleic anhydride derivatives, acrylamides, styrenic, vinyl carboxylates, acrylonitriles, or the like, or a combination comprising at least one of the foregoing.

An exemplary polymer is polyvinyl butyral.

The polymer is generally present in the mixture prior to extrusion in an amount of 0.1 to 80 wt %, 1 to 70 wt %, and 2 to 50 wt %, based on a total weight of the mixture. The mixture includes the sorbent particle in powder form, the polymer, a solvent, and a non-solvent. In an exemplary embodiment, the polymer is generally present in the mixture prior to extrusion in an amount of 0.5 to 2 wt %, and 0.8 to 1.5 wt %, based on a total weight of the mixture.

### The Solvent

A combination of a solvent and a non-solvent is used to compatibilize the sorbent particle (in powder form) with the organic polymer (also in powder form). The combination of the solvent, the non-solvent, the organic polymer, and the sorbent particle is referred to herein as a mixture. The mixing of the solvent, the non-solvent, the sorbent particle, and the organic polymer may occur outside the extruder prior to extrusion. After being mixed, the mixture is introduced directly into a hopper of the extruder. Alternatively, all of the ingredients can be mixed together in the extruder during extrusion.

In one embodiment, the non-solvent may be optional. In other words, the polymer may be mixed with only a solvent (as well as the sorbent particles or pellets) to form the mixture. The porous polymer may be produced by cooling the temperature of the mixture to below the upper critical solution temperature, where the polymer separates from the solvent to produce the porous polymer coating on the sorbent particles. In another embodiment, the temperature of the mixture may be raised above the lower critical solution temperature, where the polymer separates from the solvent to produce the porous polymer coating on the sorbent particles.

In an embodiment, the solvent and polymer can be mixed to form the solution. The sorbent particle is added to the solution. The non-solvent is added in an amount sufficient to facilitate precipitation of the polymer on the sorbent particle.

The solvent is compatible with the organic polymer, while the non-solvent will not solvate the organic polymer. The non-solvent is added to the mixture in an amount sufficient to facilitate phase separation of the polymer from the sorbent particle after the process of extrusion.

In an embodiment, the non-solvent comprises a slightly higher boiling point than the solvent. The higher boiling point facilitates a continued presence of the non-solvent in the mixture after a portion of the solvent has evaporated during extrusion. The retention of the higher boiling point non-solvent drives phase separation of the organic polymer from the sorbent particle. The organic polymer phase separates to the surface of the sorbent particle (now in pellet form after emanating from the die of the extruder). The organic polymer undergoes binodal decomposition (e.g., nucleation and growth) during the phase separation from the sorbent particle to produce a porous polymer coating on the sorbent particles (now in the form of particles 102).

The solvent and nonsolvent can be polar or non-polar solvents. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or a combination comprising at least one of the foregoing solvents. Polar protic solvents such as, but not limited to, water, methanol, acetonitrile, nitromethane, ethanol, propanol, isopropanol, butanol, or the like, or a combination comprising at least one of the foregoing polar protic solvents can be used. Other non-polar solvents such a benzene, toluene, methylene chloride, carbon tetrachloride, hexane, diethyl ether, tetrahydrofuran, or the like, or a combination comprising at least one of the foregoing solvents can also be used. Co-solvents comprising at least one aprotic polar solvent and at least one non-polar solvent can also be utilized. In an embodiment, the solvent can be liquid carbon dioxide, liquid nitrogen, or a combination comprising at least one of the foregoing. In an embodiment, the solvent can be supercritical carbon dioxide or supercritical nitrogen.

An exemplary solvent is an alcohol (e.g., methanol, ethanol, propanol, or the like). An exemplary nonsolvent is water.

The solvent is generally present in the mixture in an amount effective to solvate the particular polymer. The solvent is generally present in the mixture prior to extrusion in an amount of 5 to 55 wt %, based on a total weight of the mixture. In an exemplary embodiment, the solvent is generally present in the mixture prior to extrusion in an amount of 7 to 45 wt %, based on a total weight of the mixture.

The non-solvent is generally present in the mixture prior to extrusion in an amount of 1 to 50 wt %, based on a total weight of the mixture. In an exemplary embodiment, the non-solvent is generally present in the mixture prior to extrusion in an amount of 2 to 30 wt %, based on a total weight of the mixture.

In an embodiment, the ratio of the volume of the solvent to the non-solvent is 10:1 to 1:1. In an exemplary embodiment, the ratio of the volume of the solvent to the non-solvent is 5:1 to 2:1.

### The Method of Manufacturing

The sorbent particle may be coated with the porous polymeric coating in a single step or in multiple steps. In the single step method, all ingredients (the sorbent particle, the polymer and the solvent/non-solvent) are directly fed to an extruder. The polymer coating is formed on the particles by phase inversion as detailed below. There are several multiple step methods by which the sorbent particles may be coated. In one method, the ingredients may be mixed in a first mixer to form a uniform homogeneous mixture. The mixture is fed to an extruder and results in the formation of a coated particles upon extrusion as detailed below. The extruder may therefore be used in a single step process or in a multi-step process to facilitate the coating of the particles.

In yet another method that includes more than a single step, the sorbent particle (without the polymer and the solvent) may be formed into pellets either via extrusion or via molding (injection molding, compression molding, and the like). The pellets of the sorbent particle may then be coated via pan coating or dip coating in a separate step This is discussed in detail below.

In one embodiment, in one manner of manufacturing the coated particles, the ingredients (i.e., the sorbent particle, the organic polymer, the solvent and the non-solvent) are fed into the extruder either separately or as a mixture. When the ingredients are fed into the extruder as a mixture, the ingredients may be mixed together in a Waring blender, a Henschel mixer, a planetary mixer, a Helicone mixer, or the like.

The mixture is introduced into the hopper of the extruder. The temperature and pressure within the extruder are set so that the polymer is in a single phase with the solvent and non-solvent. Upon extrusion, the mixture exits the die in the form of a strand. The strand is then pelletized in a pelletizer. The change in pressure and temperature encountered by the strand upon emanating from the extruder, results in the polymer separating from the sorbent particle and forming a porous coating upon the sorbent particle. The particles (or pellets) formed upon pelletization each have a porous coating disposed on the sorbent particle (in pellet or particulate form) as depicted in the FIG. 1.

During the extrusion, some of the solvent (which typically has a lower evaporation temperature than the non-solvent evaporates) evaporates, changing the ratio of the solvent to the non-solvent. This change in the volume ratio of the solvent to the non-solvent facilitates polymer diffusion from the interior of the strand to the surface of the strand. This separation of the polymer from the sorbent particle is also referred to as phase inversion. It also promotes nucleation and growth of the solvent/non-solvent mixture within the polymer. When the solvent and non-solvent evaporate, they leave behind pores in the polymeric coating. The pores in the polymer coating are therefore formed via binodal decomposition of the polymer-solvent-non-solvent mixture.

In an embodiment, after the particles are extruded they may be subjected into molding to form a variety of different shapes. The shapes may be monolithic (i.e., they can be formed into a single indivisible object). The shapes may be 1-dimensional, 2-dimensional or 3-dimensional. For example, the particles may be in the form of a powder. Examples of 2-dimensional or 3-dimensional shapes include plates having different geometries, strands, weaves, woven textiles, spheres, and the like.

In an embodiment, the porous polymer coating can be applied to the sorbent particle by immersion precipitation. In immersion precipitation, a polymer plus solvent (polymer solution) is cast on the sorbent particle and then submerged in a bath containing nonsolvent. Due to the solvent and nonsolvent exchange, precipitation of the polymer takes place. The polymer can be soluble in solvent mixture. The combination of phase separation and mass transfer affects the coating structure. The type of polymer, solvent, and nonsolvent used, as well as the additives in the solution, impact the properties, structure, and chemical interactions of the coating.

In another embodiment, the coating may be applied to the sorbent particle via pan coating. Pan coating is a technique used to apply a coating, often a film or layer, onto solid substrates, typically in the form of small particles, granules, or tablets. While this disclosure refers to the solid sorbent as being in particle form, it may also be in the form of a sheet, a plate, a film, a strand, a sphere. Each of these different geometrical shapes may be coated via immersion precipitation, pan or drum coating.

The process involves a rotating pan or drum where the coating material is gradually applied while the substrate is tumbled to ensure uniform coverage. In this method, the sorbent particle is first pressed or extruded into a pellet (e.g., also termed a sized pellet). These pellets form the substrates that are placed in the pan and tumbled with the nonsolvent. The non-solvent can be sprayed into the pan. The non-solvent ban be sprayed into the pan prior to the addition of the pellets. The polymer dissolved in a solvent is gradually added to the pan. In an embodiment, the polymer solvent solution can be sprayed into the pan. As the sorbent particles or pellets are tumbled, they are coated with the porous film of the polymer as the polymer precipitates from the solution due to the exchange of the solvent with the nonsolvent. The porous coating is formed via binodal decomposition as detailed above.

In another embodiment, the sorbent particles may be dip coated in a solution containing the polymer. In this embodiment, the sorbent particles are wetted with a nonsolvent. The wetted sorbent particles are then dipped in the polymer solvent solution. Upon exchange of the solvent and nonsolvent, the polymer precipitates leaving a porous coating on the surface of the sorbent particle particles. The pores are formed in the polymer coating via binodal decomposition as detailed above. Dip coating is a method used to apply a uniform coating onto particles, substrates, or surfaces by immersing them into a coating solution and then withdrawing them under controlled conditions. When applied to particles, dip coating involves suspending the sorbent particles in the coating liquid and controlling the deposition process to achieve a uniform layer.

Porous coatings comprise holes, pores, voids, or discontinuities in the coating that offer pathways for the air to flow across the coating and reach the particle with low or reduced impact on the air diffusional kinetics. The polymer coating reduces dust formation when the coated particles are transported or subjected to additional processes.

The porous polymeric coating 104 comprises a thickness of about 0.001 micrometers to 1 millimeter, about 0.01 micrometers to 1 millimeter, about 1 micrometer to 100 micrometers, or 10 micrometers to 50 micrometers. The term “coating” as used herein refers to a porous polymer film that contacts (e.g., that is located on or encapsulates) the particle. The coating comprises a different composition from that of the particle and is less than about 5 weight percent (wt %) of the total weight of the sorbent.

In an embodiment, the solid sorbent particles after being coated can be molded into a monolithic article. The monolithic article can be a membrane, a coating, or the like.

The ability to tune the composition of the coating allow for control of chemical properties and functionality such as hydrophilicity, hydrophobicity, carbon dioxide or water diffusivity and thermal and chemical stability. The creation of pores due to fast precipitation of a thin polymer layer by using phase inversion techniques allows for tuning of the coating composition for selectively binding carbon dioxide. The porous polymeric coating provides anti-shattering properties and exhibits pores or discontinuities. The pores allow for the air to flow across and reach the particles with low or reduced impact on the air diffusional kinetics. It mitigates the formation of fines during their operations in moving and fluidized bed configurations

### EXAMPLES

Polyvinyl butyral (which is the polymer) (in an amount of 1 gram) is mixed with methanol (in an amount of 99 grams) to form the polymer-solvent solution. The sorbent which is a metal-organic framework material is wetted with water. In this example, the metal organic framework in in pellet form prior to being wetted with water. The molecular organic framework is present in an amount of 52 grams. Water is the non-solvent and is used in an amount of 10 grams. As the polymer-solvent solution is mixed with the wetted sorbent, the polymer precipitates forming a polyvinyl butyral coating on the surface of the sorbent.

As shown in FIG. 1B, the coating reveals that a textured polymeric phase is homogeneously covering the material extrudate upon coating as analyzed via optical microscopy. When the material (i.e., the polyvinyl butyral polymer) is peeled off from the extruded material, a thin and porous coating is shown.

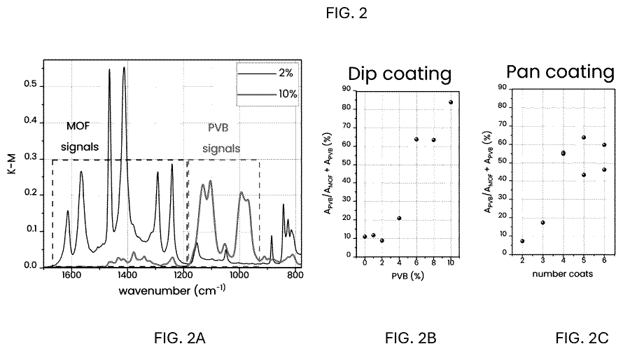

The characteristics of the porous coating, including thickness, and porosity can be tuned by the choice on the selection of solvents, polymer composition and concentrations and time of exposure during dipping or spraying. For instance, varying the polyvinyl butyral concentration in methanol allows for the controlled the thickness of the polyvinyl butyral coating, as measured by attenuated total reflectance (ATR) in FIGS. 2A, 2B and 2C.

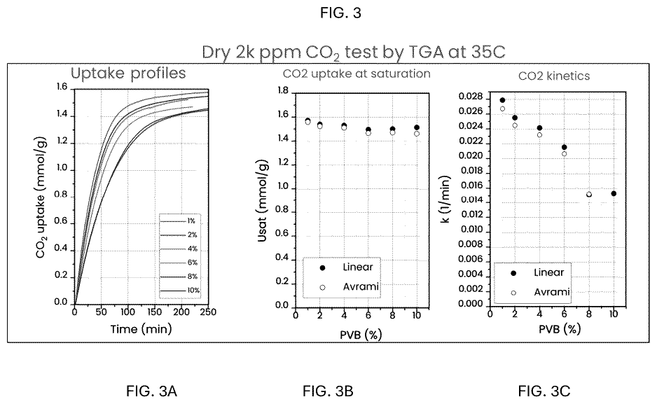

ATR characterization is a surface characterization that allow 0.5 to 5 micrometer depth detection of the coatings on the external surfaces. By varying the polyvinyl butyral concentration in methanol, the thickness of the polyvinyl butyral coating can be controlled., as measured by ATR in FIGS. 3A, 3B, and 3C. ATR spectra for two polyvinyl butyral-coated metal-organic framework sorbent materials using 0.1 wt % and 10 wt % of polyvinyl butyral in methanol. Ratio between ATR signals of polyvinyl butyral to polyvinyl butyral and metal-organic framework ratio for a showcase of dip coating technique (middle) and pan coating technique (right).

FIGS. 3A, 3B, and 3C show the impact of coatings on uptake (FIG. 3A) and kinetics (FIG. 3B). The uptake/kinetic analysis were performed by exposing the material to 2000 ppm carbon dioxide at 35 °C by thermogravimetric analysis (TGA). The incorporation of the porous coating leads to small and proportional to mass of coating drop in carbon dioxide uptake, and a linear drop in the kinetics till 8% polyvinyl butyral, in which more coating does not lead to slower kinetics due to the porous nature of the coating.

FIG. 3A illustrate the impact on carbon dioxide adsorption performance of the characteristics of the porous coating using polyvinyl butyral at varying concentration in methanol via dip coating. Carbon dioxide adsorption profiles are shown at 35 degrees Celsius with under 2000 ppm carbon dioxide in air by TGA at varying amounts of polyvinyl butyral.

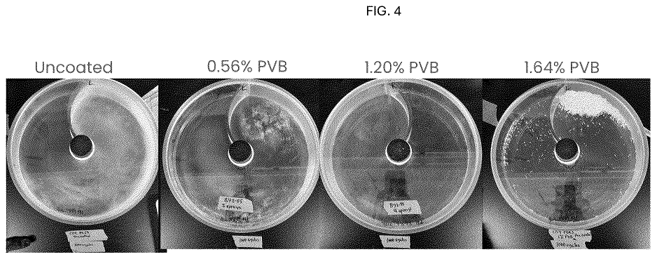

Coated material was also exposed to attrition forces using a rotating drum to visually inspect the effect of coatings on the formation of fines. As shown in FIG. 4, significant mitigation of fines formation is observed when comparing increasing amount of polyvinyl butyral coating (1.64 wt %) to the sum of the initial uncoated material (the solid sorbent) and the polyvinyl butyral coating.

Mitigation of fines generation leads to longer lifetime of particle materials, better carbon dioxide productivity, and lower cost for the carbon dioxide adsorption. In addition, the reduction of fines helps reduce the equipment maintenance, including less cleaning proceedings involving removal of fines from airways and valves, and less worn, corrosion, and degradation of the equipment.

Embodiment 1: A coated solid sorbent particle for adsorbing a fluid, the coated particle including a solid sorbent particle that is operative to adsorb the fluid, and a porous polymer coating disposed on the solid sorbent particle.

Embodiment 2: The coated particle of any prior embodiment, where the solid sorbent particle is operative to adsorb the fluid and to desorb the fluid.

Embodiment 3: The coated particle of any prior embodiment, wherein the solid sorbent particle comprises a surface area greater than 10 m²/gm.

Embodiment 4: The coated particle of any prior embodiment, wherein the solid sorbent particle comprises a metal-organic framework and wherein the metal-organic framework comprises a metal, a linker and a ligand.

Embodiment 5: The coated particle of any prior embodiment, wherein the metal comprises aluminum, beryllium, calcium, cadmium, cobalt, chromium, copper, iron, magnesium, manganese, nickel, scandium, titanium, vanadium, zinc, or a combination comprising at least one of the foregoing.

Embodiment 6: The coated particle of any prior embodiment, wherein the linker comprises a pyrazolate group, a triazolate group, a tetrazolate group, a carboxylate group or a combination comprising at least one of the foregoing; and wherein the ligand comprises an amine.

Embodiment 7: The coated particle of any prior embodiment, where the amine comprises ethylenediamine, propylenediamine, butylenediamine, pentylenediamine, hexylenediamine, 2-(diisopropylphosphino)ethylamine N-methylethanolamine, and monoethanolamine 1,2-propanediamine, 2,3-butanediamine, 1,2-diamino-2-methylpropane, N-boc-ethylenediamine, N-ethylethylenediamine, N,N′-diethylpropylenediamine, N,N-diethylethylenediamine, N-isopropylethylenediamine, N,N′-diisopropylethylenediamine, N-isopropylpropylenediamine, N,N′-diisopropylpropylenediamine, N,N′-diisopropylethylenediamine, N-methylethylenediamine, N,N′-dimethylethylenediamine, N-methylpropylenediamine, N,N′-dimethylpropylenediamine, 1,3-diaminocyclohexane, N,N-dimethylethylenediamine, N,N,N′-trimethylethylenediamine, N,N,N′,N′-tetramethylethylenediamine, N-trimethylsilylethylenediamine, N,N-bis(trimethylsilyl)ethylenediamine, N,N′-bis(trimethylsilyl)ethylenediamine, N,N-dimethylpropylenediamine, N,N,N′-trimethylpropylenediamine, N,N,N′,N′-tetramethylpropylenediamine, diethylenetriamine, 2-(2-aminoethyoxy)ethylamine, dipropylenetriamine, 1,2-diaminocyclohexane, piperazine, and tris(2-aminoethyl)amine, bis(3-aminopropyl)amine, N,N′-bis(3-aminopropyl)-1,4-butanediamine, tetraethylene pentaamine, polyethyleneimine, polypropyleneimine, or a combination comprising at least one of the foregoing.

Embodiment 8: The sorbent of any prior embodiment, wherein the porous polymer coating comprises an organic polymer.

Embodiment 9: The coated particle of any prior embodiment, wherein organic polymer comprises polyvinyl butyral, polylactic acid, poly(ethylene glycol), polycaprolactone, polyhydroxybutyrate, or a combination comprising at least one of the foregoing.

Embodiment 10: The coated particle of any prior embodiment, wherein the porous polymeric coating comprises a thickness of 0.001 micrometers to 1 millimeter.

Embodiment 11: The coated particle of any prior embodiment, wherein the fluid is one or more of carbon dioxide, nitrogen, carbon monoxide, oxygen, water vapor, sulfurous oxides or nitrogen oxides.

Embodiment 12: An article comprising the coated particle of any prior embodiment.

Embodiment 13: The article of any prior embodiment, where the particle is a membrane, a coating, a weave, a pellet, a monolith, or a powder.

Embodiment 14: A method of coating a fluid adsorbing solid sorbent particle, the method including disposing a porous polymer coating on the fluid adsorbing solid sorbent particle.

Embodiment 15: The method of any prior embodiment, wherein the disposing the porous polymer coating comprises contacting the solid sorbent particle with a nonsolvent followed by contacting the nonsolvent coated solid sorbent particle with a solution of a polymer and a solvent.

Embodiment 16: The method of any prior embodiment, wherein the porous polymer coating is applied by dip coating or pan coating.

Embodiment 17: The method of any prior embodiment, wherein the polymer is compatible with the solvent and is incompatible with the nonsolvent.

Embodiment 18: The method of any prior embodiment, wherein the polymer comprises polyvinyl butyral, polylactic acid, poly(ethylene glycol), polycaprolactone, polyhydroxybutyrate, or a combination comprising at least one of the foregoing; wherein the solvent comprises methanol, ethanol, propanol, isopropanol, butanol, or a combination comprising at least one of the foregoing; and wherein the nonsolvent comprises water.

Embodiment 19: The method of any prior embodiment, wherein the porous polymeric coating comprises a thickness of 0.001 micrometers to 1 millimeter.

Embodiment 20: The method of any prior embodiment, wherein the disposing the porous polymer coating is accomplished by extruding the solid sorbent particle along with a polymer-solvent solution and a non-solvent.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ±8% of a given value.

While the invention has been described with reference to an exemplary embodiment or embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms can have been employed, they are unless otherwise stated used in a generic and descriptive sense only and not for purposes of limitation, the scope of the invention therefore not being so limited.

What is claimed is:

1. A coated solid sorbent particle for adsorbing a fluid, the coated particle comprising:
a solid sorbent particle that is operative to adsorb the fluid, and
a porous polymer coating disposed on the solid sorbent particle.

2. The coated particle of claim 1, where the solid sorbent particle is operative to adsorb the fluid and to desorb the fluid.

3. The coated particle of claim 1, wherein the solid sorbent particle comprises a surface area greater than 10 m²/gm.

4. The coated particle of claim 1, wherein the solid sorbent particle comprises a metal-organic framework and wherein the metal-organic framework comprises a metal, a linker and a ligand.

5. The coated particle of claim 4, wherein the metal comprises aluminum, beryllium, calcium, cadmium, cobalt, chromium, copper, iron, magnesium, manganese, nickel, scandium, titanium, vanadium, zinc, or a combination comprising at least one of the foregoing.

6. The coated particle of claim 4, wherein the linker comprises a pyrazolate group, a triazolate group, a tetrazolate group, a carboxylate group or a combination comprising at least one of the foregoing; and wherein the ligand comprises an amine.

7. The coated particle of claim 6, where the amine comprises ethylenediamine, propylenediamine, butylenediamine, pentylenediamine, hexylenediamine, 2-(diisopropylphosphino)ethylamine N-methylethanolamine, and monoethanolamine 1,2-propanediamine, 2,3-butanediamine, 1,2-diamino-2-methylpropane, N-boc-ethylenediamine, N-ethylethylenediamine, N,N′-diethylpropylenediamine, N,N-diethylethylenediamine, N-isopropylethylenediamine, N,N′-diisopropylethylenediamine, N-isopropylpropylenediamine, N,N′-diisopropylpropylenediamine, N,N′-diisopropylethylenediamine, N-methylethylenediamine, N,N′-dimethylethylenediamine, N-methylpropylenediamine, N,N′-dimethylpropylenediamine, 1,3-diaminocyclohexane, N,N-dimethylethylenediamine, N,N,N′-trimethylethylenediamine, N,N,N′,N′-tetramethylethylenediamine, N-trimethylsilylethylenediamine, N,N-bis(trimethylsilyl)ethylenediamine, N,N′-bis(trimethylsilyl)ethylenediamine, N,N-dimethylpropylenediamine, N,N,N′-trimethylpropylenediamine, N,N,N′,N′-tetramethylpropylenediamine, diethylenetriamine, 2-(2-aminoethyoxy)ethylamine, dipropylenetriamine, 1,2-diaminocyclohexane, piperazine, and tris(2-aminoethyl)amine, bis(3-aminopropyl)amine, N,N′-bis(3-aminopropyl)-1,4-butanediamine, tetraethylene pentaamine, polyethyleneimine, polypropyleneimine, or a combination comprising at least one of the foregoing.

8. The sorbent of claim 1, wherein the porous polymer coating comprises an organic polymer.

9. The coated particle of claim 8, wherein organic polymer comprises polyvinyl butyral, polylactic acid, poly(ethylene glycol), polycaprolactone, polyhydroxybutyrate, or a combination comprising at least one of the foregoing.

10. The coated particle of claim 1, wherein the porous polymeric coating comprises a thickness of 0.001 micrometers to 1 millimeter.

11. The coated particle of claim 1, wherein the fluid is one or more of carbon dioxide, nitrogen, carbon monoxide, oxygen, water vapor, sulfurous oxides or nitrogen oxides.

12. An article comprising the coated particle of claim 1.

13. The article of claim 12, where the particle is a membrane, a coating, a weave, a pellet, a monolith, or a powder.

14. A method of coating a fluid adsorbing solid sorbent particle, the method comprising:
disposing a porous polymer coating on the fluid adsorbing solid sorbent particle.

15. The method of claim 14, wherein the disposing the porous polymer coating comprises contacting the solid sorbent particle with a nonsolvent followed by contacting the nonsolvent coated solid sorbent particle with a solution of a polymer and a solvent.

16. The method of claim 14, wherein the porous polymer coating is applied by dip coating or pan coating.

17. The method of claim 15, wherein the polymer is compatible with the solvent and is incompatible with the nonsolvent.

18. The method of claim 15, wherein the polymer comprises polyvinyl butyral, polylactic acid, poly(ethylene glycol), polycaprolactone, polyhydroxybutyrate, or a combination comprising at least one of the foregoing; wherein the solvent comprises methanol, ethanol, propanol, isopropanol, butanol, or a combination comprising at least one of the foregoing; and wherein the nonsolvent comprises water.

19. The method of claim 14, wherein the porous polymeric coating comprises a thickness of 0.001 micrometers to 1 millimeter.

20. The method of claim 14, wherein the disposing the porous polymer coating is accomplished by extruding the solid sorbent particle along with a polymer-solvent solution and a non-solvent.
